(19) United States
(12) Patent Application Publication
(10) Pub. No.: US 2009/0121699 A1
(43) Pub. Date: May 14, 2009

(54) BANDGAP REFERENCE VOLTAGE GENERATION CIRCUIT IN SEMICONDUCTOR MEMORY DEVICE

(76) Inventors: Jae-Boum PARK, Kyoungki-do (KR); Sang-Jin Byeon, Kyoungki-do (KR)

Correspondence Address: MANNAVA & KANG, P.C., 11240 WAPLES MILL ROAD, Suite 300, FAIRFAX, VA, 22030, US

(21) Appl. No.: 12/165,198

(22) Filed: Jun. 30, 2008

(30) Foreign Application Priority Data
Nov. 8, 2007 (KR) 10-2007-0113664

(51) Int. Cl. G05F 3/16

(52) U.S. Cl. 323/313

(57) ABSTRACT

Bandgap reference voltage generation circuit in semiconductor memory device includes a first current generator configured to generate a first current proportional to a change of a temperature by using temperature characteristic of a diode-connected MOS transistor, a second current generator configured to generate a second current inversely proportional to the change of the temperature by using the temperature characteristic of a diode-connected MOS transistor and a summation unit configured to mirror and sum the output currents of the first current generator and the second current generator, and output a reference voltage.

### CROSS-REFERENCES TO RELATED APPLICATIONS

The present invention claims priority of Korean patent application numbers 10-2007-0113664, filed on Nov. 8, 2007, which is incorporated by reference in their entirety.

### BACKGROUND OF THE INVENTION

The present invention relates to a semiconductor design technology, and more particularly, to an internal voltage generation circuit of a semiconductor memory device. More specifically, the present invention relates to a bandgap reference voltage generation circuit.

A semiconductor memory device generates a variety of internal voltages using an external power voltage (VDD) and a ground voltage (VSS). A dynamic random memory access (DRAM), which is a representative semiconductor memory device, internally generates a core voltage (VCORE) used as a voltage level corresponding to data ‘1’ in a memory core region, a high voltage (VPP) used as a word ling enabling voltage of a cell transistor, and a back bias voltage (VBB) used as a bulk bias of a cell transistor.

In order to generate these internal voltages, the semiconductor memory device uses a charge pumping scheme for the back bias voltage (VBB) and the high voltage (VPP) or a voltage down-converting scheme for the core voltage (VCORE). Although the semiconductor memory device uses either the charge pumping scheme or the voltage down-converting scheme, it generates a reference voltage VREF as a reference level of the internal voltage and generates the internal voltages (VBB, VPP, or VCORE) using the reference voltage VREF.

Meanwhile, in order to generate the reference voltage VREF with a stable level, the semiconductor memory device must generate a source voltage having a constant level, regardless of the changes of a process, a voltage and a temperature (PVT). A bandgap reference voltage generation circuit is generally used to generate the source voltage.

Generally, the bandgap reference voltage generation circuit uses the complementary proportional to absolute temperature (CTAT) characteristics of the base-emitter voltage (Vbe) of a bipolar junction transistor (BJT).

Meanwhile, since the semiconductor memory devices, particularly semiconductor memory devices such as a DRAM, are used in portable devices such as a notebook computer, they are required to have a large capacity, a high operating speed, a small size, and a low power consumption. As one solution for low-power semiconductor memory device, the power supply voltage (VDD) is gradually lowered. At present, the semiconductor memory device requires a power supply voltage (VDD) of less than 1.5V.

Under the low power supply voltage (VDD) environment, a reference voltage is further required for securing an immunity to the changes of the PVT. However, since a conventional bandgap reference voltage generation circuit using the CTAT characteristics of the base-emitter (Vbe) of the BJT basically uses both the BJT and MOSFET, its fabrication process is complicated and its layout area is large. Moreover, when the conventional bandgap reference voltage generation circuit intends to generate a temperature-independent voltage, its output level is limited to 1.19 V. That is, it is difficult to control the output level independent of the temperature characteristic. When intending to compensate the output level of the conventional bandgap reference voltage generation circuit, there are limitations in the layout area and power consumption.

### SUMMARY OF THE INVENTION

Embodiments of the present invention are directed to providing a bandgap reference voltage generation circuit in a semiconductor memory device, which can generate a bandgap reference voltage having immunity to the changes of the PVT under low operating voltage environment.

Embodiments of the present invention are also directed to providing a bandgap reference voltage generation circuit in a semiconductor memory device, which is capable of controlling an output level independent of temperature characteristic without increasing a layout area.

In accordance with an aspect of the present invention, there is provided a first current generator configured to generate a first current proportional to a change of a temperature by using temperature characteristic of a diode-connected MOS transistor, a second current generator configured to generate a second current inversely proportional to the change of the temperature by using the temperature characteristic of a diode-connected MOS transistor and a summation unit configured to mirror and sum the output currents of the first current generator and the second current generator, and output a reference voltage.

### BRIEF DESCRIPTION OF THE DRAWINGS

FIG. 1 is a circuit diagram of a bandgap reference voltage generation circuit in a semiconductor memory device in accordance with one embodiment of the present invention.

### DESCRIPTION OF SPECIFIC EMBODIMENTS

Hereinafter, a bandgap reference voltage generation circuit in a semiconductor memory device in accordance with the present invention will be described in detail with reference to the accompanying drawings.

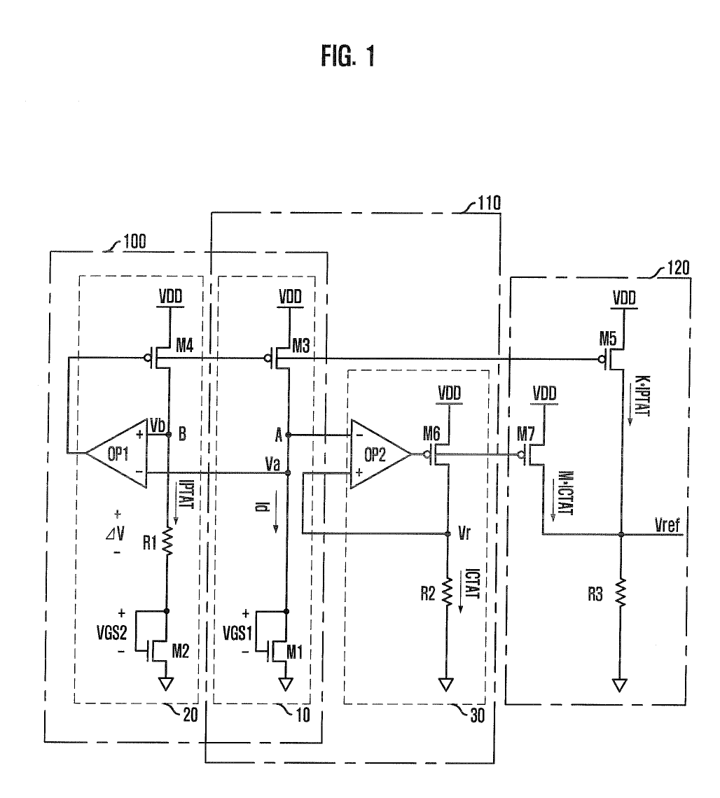

FIG. 1 is a circuit diagram of a bandgap reference voltage generation circuit in a semiconductor memory device in accordance with one embodiment of the present invention.

Referring to FIG. 1, a bandgap reference voltage generation circuit in accordance with one embodiment of the present invention includes a first current generator 100, a second current generator 110, and a summation unit 120. The first current generator 100 generates a current IPTAT proportional to the change of a temperature by using the temperature characteristic of a diode-connected NMOS transistor. The second current generator 110 generates a current ICTAT inversely proportional to the change of a temperature by using the temperature characteristic of a diode-connected NMOS transistor. The summation unit 120 mirrors and sums the output current of the first current generator 100 and the output current of the second current generator 110, and outputs a reference voltage Vref.

The first current generator 100 includes a first bandgap unit 10 configured to generate a first voltage Va inversely proportional to the change of the temperature, and a second bandgap unit 20 configured to generate the current IPTAT proportional to the change of the temperature by using the first voltage Va.

The second bandgap unit 20 includes: an operational amplifier OP1 configured to receive the first voltage Va and a second voltage Vb of a node B; a PMOS transistor M4 having a source connected to a power supply voltage (VDD) terminal, a drain connected to the node B, and a gate receiving the output signal of the operational amplifier OP1; a diode-connected NMOS transistor M2 having a source connected to a ground voltage (VSS) terminal, and a gate and a drain connected to each other; and a resistor R1 connected between the node B and the drain of the NMOS transistor M2.

The first bandgap unit 10 includes: a PMOS transistor M3 having source connected to the VDD terminal, a drain connected to a node A (the output node of the first voltage Va), and a gate receiving the output signal of the operational amplifier OP1; and a diode-connected NMOS transistor M1 having a source connected to the VSS terminal, and a drain and a gate commonly connected to the node A. The NMOS transistor M2 is designed to have a size N times larger than the NMOS transistor M1.

The second current generator 110 includes the first bandgap unit 10, and a voltage-to-current conversion unit 30 configured to convert the first voltage Va into the corresponding current ICTAT.

The voltage-to-current converter 30 includes: an operational amplifier OP2 configured to receive the first voltage Va and a feedback voltage Vr; a PMOS transistor M6 having a source connected to the VDD terminal, a drain connected to the Vr node, and a gate receiving the output signal of the operational amplifier OP2; and a resistor R2 connected between the Vr node and the VSS terminal.

The summation unit 120 includes: a PMOS transistor M5 having a source connected to the VDD terminal, a drain connected to the Vref terminal, and a gate receiving the output signal of the operational amplifier OP1; a PMOS transistor M7 having a source connected to the VDD terminal, a drain connected to the Vref terminal, and a gate receiving the output signal of the operational amplifier OP2; and a resistor R3 connected between the Vref terminal and the VSS terminal. The PMOS transistor M5 is designed to have a size K times larger than the PMOS transistor M4, and the PMOS transistor M7 is designed to have a size M times larger than the PMOS transistor M6. In mirroring the current IPTAT and the current ICTAT, the current IPTAT is amplified by K times and then mirrored, and the current ICTAT is amplified by M times and then mirrored. This is because the current IPTAT and the current ICTAT are very small.

Meanwhile, the bandgap reference voltage generation circuit in accordance with the embodiment of the present embodiment changes the turn-on degrees of the PMOS transistors M3, M4 and M5 according to the output voltage of the operational amplifier OP1 to thereby adjust an amount of current applied to the resistor R3 through the PMOS transistors M3, M4 and M5. This operation is continued until the first voltage Va and the second voltage Vb, which are applied to the two input terminals of the operational amplifier OP1, have the same level. When the first voltage Va and the second voltage Vb having the same level are input to the two input terminals of the operational amplifier OP1 respectively, the bandgap reference voltage generation circuit generates the reference voltage Vref having a constant level, regardless of the changes of the PVT.

When the operational amplifier OP1 has a sufficiently large gain, the node A and the node B form a virtual short so that the first voltage Va and the second voltage Vb have the same level (Va=Vb). At this point, the PMOS transistor M3 receives the first voltage Va through the drain, and the PMOS transistor M4 receives the second voltage Vb through the drain. The gate of the PMOS transistors M3 and the gate of the PMOS transistor M4 receive the output voltage of the operational amplifier OP1, and the source of the PMOS transistors M3 and the source of the PMOS transistor M4 receive the power supply voltage VDD. Accordingly, even though the channel length modulation of the PMOS transistors M3 and M4 are considered, the same current flows through the PMOS transistors M3 and M4.

Therefore, assumed that the first voltage Va and the second voltage Vb have the same level and the same current flows through the PMOS transistors M3 and M4, a current flowing through the NMOS transistor M1 may be expressed as Equation 1 below.

$$\begin{matrix}{I}_{d} = \frac{1}{2} {μ}_{n} {C}_{ox} \frac{W}{L} {( {V}_{GS} - {V}_{tn} )}^{2} \\ {μ}_{n} {C}_{ox} \frac{W}{L} = β \\ {I}_{d} = \frac{1}{2} {β ( {V}_{GS} - {V}_{tn} )}^{2}\end{matrix} \qquad ( Eq . 1 )$$

The gate-source voltage V_{GS} is expressed as Equation 2 below:

$${V}_{GS} = \sqrt{\frac{2 {I}_{d}}{β}} + {V}_{tn} \qquad ( Eq . 2 )$$

Due to the operational amplifier OP1, the first voltage Va is equal to the second voltage Vb, and the current IPTAT is equal to the current I_{d}. Accordingly, a voltage applied across the resistor R1 due to IR drop corresponds to the voltage difference between V_{GS1} of the diode-connected NMOS transistor M1 and V_{GS2} of the diode-connected NMOS transistor M2, as expressed in Equation 3 below.

ΔV=V_{GS1}−V_{GS2} (Eq. 3)

From Equations 1 to 3, the current IPTAT may be expressed as Equation 4 below.

$$\begin{matrix}IPTAT \cdot {R}_{1} = \sqrt{\frac{2 \cdot IPTAT}{β}} + {V}_{tn} - \sqrt{\frac{2 \cdot IPTAT}{N β}} - {V}_{tn} \\ IPTAT = \frac{1}{{R}_{1}} ( 1 - \frac{1}{\sqrt{N}} ) \sqrt{\frac{2 \cdot IPTAT}{β}} \\ IPTAT = \frac{2}{{R}_{1}^{2}} \frac{1}{{μ}_{n} {C}_{ox} \frac{W}{L}} {( 1 - \frac{1}{\sqrt{N}} )}^{2}\end{matrix} \qquad ( Eq . 4 )$$

In Equation 4, the parameter influencing temperature is the mobility μₙ.

If the partial differentiation of the mobility μn is performed with respect to absolute temperature in the operating temperature region of a device, it has a negative value. That is, the mobility μₙ decreases as the temperature increases. In Equation (4), since the mobility μₙ is in a denominator, it can be seen that the current IPTAT exhibits a proportional to absolute temperature (PTAT) characteristic. That is, the current IPTAT increases as the temperature increases.

Since the operational amplifier OP2 receives the first voltage Va as a first input and the feedback voltage Vr as a second input, the first voltage Va and the feedback voltage Vr have the same level due to the virtual short. Accordingly, the feedback voltage Vr divided by the resistance R₂ of the resistor R2 is the current ICTAT, which becomes a value obtained by dividing the voltage V_{GS1} by the resistance R₂ of the resistor R2. The current ICTAT is expressed as Equation 5 below.

$$\begin{matrix}ICTAT = \frac{{V}_{GS 1}}{{R}_{2}} = \frac{1}{{R}_{2}} ( \sqrt{\frac{2 {I}_{d}}{β}} + {V}_{tn} ) \\ ICTAT = \frac{1}{{R}_{2}} ( \frac{2}{{R}_{1} {μ}_{n} {C}_{ox} \frac{W}{L}} ( 1 - \frac{1}{\sqrt{N}} ) + {V}_{tn} )\end{matrix} \qquad ( Eq . 5 )$$

In Equation (5), only the mobility μₙ and the voltage Vₜₙ is a temperature related function. If the partial differentiation of the voltage Vₜₙ is performed with respect to absolute temperature, it has a negative value. That is, the voltage Vₜₙ decreases as the temperature increases. Since the voltage Vₜₙ is in a numerator, the current ICTAT decreases as the temperature increases. The current ICTAT has both a component increasing in proportion to the temperature and a component decreasing in inverse proportion to the temperature, but the current ICTAT may be controlled to have characteristics decreasing in inverse proportion to the increase of the temperature by adjusting the resistance R₁ of the resistor R1, the parameter W/L, and the parameter N.

The gates of the PMOS transistors M3, M4 and M5 are commonly connected to the output terminal of the operational amplifier OP1. The current flowing through the PMOS transistor M5 has K times the current IPTAT of the PMOS transistor M4, as expressed in Equation 6 below.

I_{M5}=K·IPTAT (Eq. 6)

Also, the gates of the PMOS transistors M6 and M7 are commonly connected to the output terminal of the operational amplifier OP2. Accordingly, the current flowing through the PMOS transistor M7 has M times the current ICTAT of the PMOS transistor M6, as expressed in Equation 7 below.

I_{M7}=M·ICTAT (Eq. 7)

In this way, since the current of the PMOS transistor M7 is M·ICTAT and the current of the PMOS transistor M5 is K·IPTATA, the current corresponding to the sum of M·ICTAT and K·IPTATA flows through the resistor R3. Therefore, the reference voltage Vref as a final output may be expressed as Equation 8 below.

$$\begin{matrix}Vref = {R}_{3} ( K \cdot IPTAT + M \cdot ICTAT ) \\ Vref = {R}_{3} [ \frac{K}{{R}_{1}^{2}} \frac{2}{{μ}_{n} {C}_{ox} \frac{W}{L}} {( 1 - \frac{1}{\sqrt{N}} )}^{2} + \\ \frac{M}{{R}_{2}} \frac{2}{{R}_{1} {μ}_{n} {C}_{ox} \frac{W}{L}} ( 1 - \frac{1}{\sqrt{N}} ) + \frac{M}{{R}_{2}} {V}_{tn} ]\end{matrix} \qquad ( Eq . 8 )$$

According to Equation 8, it can be seen that the reference voltage Vref is generated by the combination of the PTAT component and CTAT component.

Accordingly, if the parameter values N, R₁, R₂, R₃, K and M of Equation 8 are properly adjusted to compensate the temperature, the reference voltage Vref has a constant value with respect to the change of the PVT. The current ICTAT may be adjusted by the resistance R₂ and the parameter M, and the current IPTAT may be adjusted by the resistance R₁ and the parameters K and W/L. Furthermore, the reference voltage Vref of a desired level is output by the adjustment of the resistance R₃ of the resistor R3.

The bandgap reference voltage generation circuit in accordance with the embodiment of the present invention can independently control the current of the PTAT component proportional to the change of the temperature and the current of the CTAT component inversely proportional to the change of the temperature, thereby securing the characteristics of the temperature easily. Moreover, since the bandgap reference voltage generation circuit provides a high gain, it can secure an immunity to the changes of the PVT under low operating voltage environment. Furthermore, since the bandgap reference voltage generation circuit can be implemented with only MOSFETs, its fabrication process is simplified and its layout area is minimized.

While the present invention has been described with respect to the specific embodiments, it will be apparent to those skilled in the art that various changes and modifications may be made without departing from the spirit and scope of the invention as defined in the following claims.

For example, although it has been described that the current IPTAT and the current ICTAT are generated by using the CTAT characteristic of the voltages V_{GS} of the diode-connected NMOS transistors, the diode-connected NMOS transistors can be replaced with diode-connected PMOS transistors.

What is claimed is:

1. A bandgap reference voltage generation circuit in a semiconductor memory device, comprising:
a first current generator configured to generate a first current proportional to a change of a temperature by using temperature characteristic of a diode-connected MOS transistor;
a second current generator configured to generate a second current inversely proportional to the change of the temperature by using the temperature characteristic of a diode-connected MOS transistor; and
a summation unit configured to mirror and sum the output currents of the first current generator and the second current generator, and output a reference voltage.

2. The bandgap reference voltage generation circuit as recited in claim 1, wherein the first current generator comprises:
a first bandgap unit configured to generate a first voltage inversely proportional to the change of the temperature; and
a second bandgap unit configured to generate the first current by using the first voltage.

3. The bandgap reference voltage generation circuit as recited in claim 2, wherein the second current generator comprises:
the first bandgap unit; and
a voltage-to-current conversion unit configured to convert the first voltage into the second current.

4. The bandgap reference voltage generation circuit as recited in claim 3, wherein the second bandgap unit comprises:
a first operational amplifier configured to receive the first voltage and a second voltage of a first node;
a first PMOS transistor having a source connected to a power supply voltage terminal, a drain connected to the first node, and a gate receiving the output signal of the first operational amplifier;
a first diode-connected NMOS transistor having a source connected to a ground voltage terminal, and a gate and a drain connected to each other; and
a first resistor connected between the first node and the drain of the first NMOS transistor.

5. The bandgap reference voltage generation circuit as recited in claim 4, wherein the first bandgap unit comprises:
a second PMOS transistor having a source connected to the power supply voltage terminal, a drain connected to a second node being an output node of the first voltage, and a gate receiving the output signal of the first operational amplifier; and
a second diode-connected NMOS transistor having a source connected to the ground voltage terminal, and a drain and a gate commonly connected to the second node.

6. The bandgap reference voltage generation circuit as recited in claim 5, wherein the first NMOS transistor is larger in size than the second NMOS transistor.

7. The bandgap reference voltage generation circuit as recited in claim 5, wherein the voltage-current conversion unit comprises:
a second operational amplifier configured to receive the first voltage and a feedback voltage;
a third PMOS transistor having a source connected to the power supply voltage terminal, a drain connected to a feedback voltage node, and a gate receiving the output signal of the second operational amplifier; and
a second resistor connected between the feedback voltage node and the ground voltage terminal.

8. The bandgap reference voltage generation circuit as recited in claim 7, wherein the summation unit comprises:
a fourth PMOS transistor having a source connected to the power supply voltage terminal, a drain connected to the reference voltage terminal, and a gate receiving the output signal of the first operational amplifier;
a fifth PMOS transistor having a source connected to the power supply voltage terminal, a drain connected to the reference voltage terminal, and a gate receiving the output signal of the second operational amplifier; and
a third resistor connected between the reference voltage terminal and the ground voltage terminal.

9. The bandgap reference voltage generation circuit as recited in claim 8, wherein the fourth PMOS transistor is larger in size than the first PMOS transistor.

10. The bandgap reference voltage generation circuit as recited in claim 8, wherein the fifth PMOS transistor is larger in size than the second PMOS transistor.
